(19) United States
(12) Patent Application Publication
(10) Pub. No.: US 2023/0134019 A1
(43) Pub. Date: May 4, 2023

(54) SYSTEMS AND RELATED MANIFOLD ASSEMBLIES

(71) Applicants: Emerico Brewer, San Diego, CA (US); Travis Beckman, San Diego, CA (US); Justin Davidson, Solana Beach, CA (US)

(72) Inventors: Emerico Brewer, San Diego, CA (US); Travis Beckman, San Diego, CA (US); Justin Davidson, Solana Beach, CA (US)

(21) Appl. No.: 17/974,346

(22) Filed: Oct. 26, 2022

Related U.S. Application Data
(60) Provisional application No. 63/344,872, filed on May 23, 2022.
(60) Provisional application No. 63/273,608, filed on Oct. 29, 2021.

(51) Int. Cl. B01L 3/00

(52) U.S. Cl. CPC B01L 3/502715; B01L 3/527; B01L 2200/027; B01L 2200/0689; B01L 2200/16; B01L 2300/044; B01L 2300/0672

(57) ABSTRACT

Systems and related manifold assemblies are disclosed. In accordance with an implementation, an apparatus comprises or includes a cassette assembly of a sipper manifold assembly comprising or having a cassette housing, one or more sipper tubes, one or more sipper couplings, and one or more biasing elements. The one or more sipper tubes comprise or have a proximal end and a distal end. The one or more sipper couplings is movably coupled to the cassette housing the proximal end of the sipper tubes are coupled to the sipper couplings. The one or more biasing elements bias the one or more sipper couplings. The one or more biasing elements allow relative movement between the sipper tubes and the cassette housing.

### RELATED APPLICATION

This application claims the benefit of and priority to U.S. Provisional Patent Application No. 63/273,608, filed Oct. 29, 2021, and U.S. Provisional Patent Application No. 63/344,872, filed May 23, 2022, the content of each of which is incorporated by reference herein in their entireties and for all purposes.

### BACKGROUND

Sequencing platforms may include valves and pumps. The valves and pumps may be used to perform various fluidic operations.

### SUMMARY

In accordance with a first implementation, an apparatus comprises or includes a reagent reservoir receptacle, a sample cartridge receptacle, a reagent sipper manifold assembly, an actuator, and a sample sipper manifold assembly. The reagent reservoir receptacle is to receive a reagent reservoir and the sample cartridge receptacle is to receive a sample cartridge. The reagent sipper manifold assembly comprises or has a first end and a second end and comprises or includes one or more reagent sippers. The actuator is coupled to the first end of the reagent sipper manifold assembly to move the reagent sipper manifold assembly relative to the reagent reservoir receptacle and the sample sipper manifold assembly comprises or has one or more sample sippers. Responsive to the actuator moving the reagent sipper manifold assembly toward the reagent reservoir receptacle, the second end of the reagent sipper manifold assembly engages the sample sipper manifold assembly and moves the one or more sample sippers toward the sample cartridge receptacle.

In accordance with a second implementation, an apparatus comprises or includes a cassette assembly of a sipper manifold assembly comprising or having a cassette housing, one or more sipper tubes, one or more sipper couplings, and one or more biasing elements. The one or more sipper tubes comprise or have a proximal end and a distal end. The one or more sipper couplings is movably coupled to the cassette housing the proximal end of the sipper tubes are coupled to the sipper couplings. The one or more biasing elements bias the one or more sipper couplings and allow relative movement between the sipper tubes and the cassette housing.

In accordance with a third implementation, an apparatus comprises or includes a sample cartridge comprising or having a housing, one or more sample tubes movably coupled to the housing, and a biasing element that biases the one or more sample tubes.

In accordance with a fourth implementation, a method comprises or includes moving a reagent sipper manifold assembly toward a reagent reservoir receptacle. The reagent sipper manifold assembly comprises or has a first end and a second end and comprises or includes one or more reagent sippers. The method also comprises or includes, responsive to moving the reagent sipper manifold assembly toward the reagent reservoir receptacle, engaging the second end of the reagent sipper manifold assembly and a sample sipper manifold assembly comprising or having a sample sipper and moving the sample sipper toward a sample cartridge receptacle.

In accordance with a fifth implementation, an apparatus comprises or includes a sipper manifold assembly having a base, a carriage, a vertical guide, and a processor. The base carries a first sensor and a second sensor vertically spaced from the first sensor. The carriage carries a sipper and a first flag and a second flag defining an aperture. The vertical guide couples the base and the carriage. The processor is to identify the sipper manifold assembly being in a first position based on the first sensor sensing the first flag and not sensing the aperture and the processor is to identify the sipper manifold assembly being in a second position based on the second sensor sequentially sensing the second flag and then the aperture.

In accordance with a sixth implementation, a method comprises or includes identifying a first sensor of a sipper manifold assembly being in a closed state. The sipper manifold assembly has a base carrying the first sensor and a second sensor vertically spaced from the first sensor and a carriage carrying a sipper. The method comprises or includes determining the sipper manifold assembly is in a first position based on the first sensor being in the closed state, moving the carriage toward a second position, and identifying the second sensor of the sipper manifold assembly being in a closed state. The method comprises or includes moving the carriage a threshold distance toward the second position, identifying the second sensor of the sipper manifold assembly being in an open state, and determining the sipper manifold assembly is in the second position based on the second sensor sequentially being in the closed state and then being in the open state after the carriage is moved the threshold distance.

In further accordance with the foregoing first, second, third, fourth, fifth, and/or sixth implementations, an apparatus and/or method may further comprise or include any one or more of the following:

In accordance with an implementation, the apparatus also comprises or includes a biasing element coupling the reagent sipper manifold assembly and the sample sipper manifold assembly.

In accordance with another implementation, the biasing element is a spring.

In accordance with another implementation, the second end of the reagent sipper manifold assembly comprises or has a lip and the sample sipper manifold assembly comprises or has a lip that engage when the second end of the reagent sipper manifold assembly engages the sample sipper manifold assembly and moves the one or more sample sippers toward the sample cartridge receptacle.

In accordance with another implementation, the apparatus also comprises or includes a flow cell receptacle to receive a flow cell and a sample fluidic line coupled to each sample sipper and fluidically coupled to the flow cell.

In accordance with another implementation, the reagent reservoir receptacle comprises or has a surface that is engageable by the sample sipper manifold assembly.

In accordance with another implementation, the apparatus also comprises or includes a platform comprising or having the surface.

In accordance with another implementation, the sample sipper manifold assembly comprises or includes a base, a carriage, and a vertical guide. The carriage comprises or has a first side and a second side. The second side comprises or includes the lip and is operatively coupled to the second end of the reagent sipper manifold assembly. The vertical guide couples the base and the first side of the carriage.

In accordance with another implementation, the apparatus comprises or includes a guide coupled to the base and defines one or more apertures corresponding to the one or more sample sippers and through which the one or more sample sippers pass.

In accordance with another implementation, the apparatus comprises or includes a horizontal guide coupling the base and the guide.

In accordance with another implementation, the apparatus comprises or includes a lead screw assembly coupled to the base and to the guide.

In accordance with another implementation, the lead screw assembly comprises or includes a lead screw carried by the base and a lead nut carried by the guide.

In accordance with another implementation, the apparatus comprises or includes a cassette assembly carrying the one or more sample sippers and coupled to the carriage.

In accordance with another implementation, the cassette housing defines a cassette cavity and the one or more sipper couplings are disposed within the cassette cavity.

In accordance with another implementation, the one or more sipper tubes comprises or includes a plurality of sipper tubes and the one or more sipper couplings comprises or includes a plurality of sipper couplings.

In accordance with another implementation, each sipper coupling comprises or has a corresponding biasing element.

In accordance with another implementation, each sipper coupling comprises or includes a spring seat and the one or more biasing elements comprise or include one or more springs positioned between each spring seat and the cassette housing.

In accordance with another implementation, the sipper couplings and corresponding sipper tubes are independently movable.

In accordance with another implementation, the apparatus comprises or has a guide plate coupled to the cassette housing and defining one or more slots. Each sipper coupling comprises or has a protrusion movable within the corresponding slot.

In accordance with another implementation, each slot comprises or has opposing stops engageable by the corresponding protrusion.

In accordance with another implementation, the sample sipper manifold assembly comprises or has a base, a carriage, and a vertical guide. The carriage carries the cassette assembly and the vertical guide couples the base and the first side of the carriage.

In accordance with another implementation, the apparatus also comprises or includes a guide coupled to the base and defines one or more apertures corresponding to the one or more sample sippers and through which the one or more sample sippers pass.

In accordance with another implementation, the apparatus comprises or includes a horizontal guide coupling the base and the guide.

In accordance with another implementation, the apparatus comprises or includes a vertical guide coupling the guide and the cassette assembly.

In accordance with another implementation, the vertical guide comprises or includes a rod coupled to the guide and an aperture of the cassette housing receiving the rod.

In accordance with another implementation, the one or more sipper tubes comprises or includes a plurality of sipper tubes that are coupled to the sipper coupling.

In accordance with another implementation, the sipper tubes move together.

In accordance with another implementation, the distal end of each of the sipper tubes comprises or has a first surface positioned at a first angle relative to a longitudinal axis of the corresponding sipper tube and a second surface positioned at a second angle relative to the longitudinal axis of the corresponding sipper tube.

In accordance with another implementation, the apparatus comprises or includes a horizontal linear guide coupling the cassette assembly and the carriage.

In accordance with another implementation, the one or more sample tubes comprise or include a plurality of sample tubes.

In accordance with another implementation, the sample tubes are independently movable relative to the housing.

In accordance with another implementation, the sample tubes are coupled together and comprise or have a flange that engages the biasing element.

In accordance with another implementation, the biasing element comprises foam.

In accordance with another implementation, the one or more sample tubes comprise or have a conical portion that tapers toward a recessed portion.

In accordance with another implementation, the method also comprises or includes piercing a liquid impermeable barrier covering a sample well received within the sample cartridge receptacle.

In accordance with another implementation, piercing the liquid impermeable barrier comprises or includes a sipper coupling of the sample sipper engaging a stop and a distal end of the sample sipper piercing the liquid impermeable barrier.

In accordance with another implementation, the method comprises or includes moving the sample sipper relative to a carriage of the sipper manifold assembly.

In accordance with another implementation, moving the sample sipper comprises or includes moving the sample sipper against a biasing force.

In accordance with another implementation, the biasing force is provided by one or more springs.

In accordance with another implementation, the biasing force is provided by foam.

In accordance with another implementation, at least one of 1) the second end of the reagent sipper manifold assembly has a lip that engages the sipper manifold assembly when the second end of the reagent sipper manifold assembly engages the sample sipper manifold assembly and moves the one or more sample sippers toward the sample cartridge receptacle or 2) the sample sipper manifold assembly has a lip that engages with the second end of the reagent sipper manifold assembly when the second end of the reagent sipper manifold assembly engages the sample sipper manifold assembly and moves the one or more sample sippers toward the sample cartridge receptacle.

In accordance with another implementation, the sipper manifold assembly comprises or includes a reagent sipper manifold assembly.

In accordance with another implementation, the first position and the second position are a first distance apart and the first sensor and the second sensor are a second distance apart. The first distance is greater than the second distance.

In accordance with another implementation, the first distance is about 74 millimeters.

In accordance with another implementation, the second sensor sensing the aperture comprises or includes the second sensor being in an open state.

In accordance with another implementation, the processor identifying the sipper manifold assembly being in the second position comprises or includes the second sensor sequentially being in a closed state and then being in an open state.

In accordance with another implementation, the second sensor being in the open state comprises or includes the second sensor sensing the aperture.

In accordance with another implementation, the apparatus comprises or includes a flag assembly comprising or including the first flag and the second flag.

In accordance with another implementation, the flag assembly comprises or includes a body from which the first flag and the second flag extend.

In accordance with another implementation, the apparatus comprises or includes a sensor assembly comprising or including a sensor board, the first sensor, and the second sensor.

In accordance with another implementation, the apparatus comprises or includes a lead screw assembly coupled to the base and to the carriage.

In accordance with another implementation, the threshold distance is approximately 2.75 millimeters.

In accordance with another implementation, the carriage carries a first flag and a second flag defining an aperture.

In accordance with another implementation, determining the sipper manifold assembly is in the second position based on the second sensor sequentially being in the closed state and then being in the open state comprises or includes the second sensor sequentially sensing the second flag and the aperture.

In accordance with another implementation, the aperture comprises or includes a through hole.

In accordance with another implementation, the aperture comprises or includes a cut-out.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is an isometric view of an example sample sipper manifold assembly that can be used to implement the sample sipper manifold assembly of FIG. 1.

FIG. 3 shows an expanded isometric view of the sipper manifold assembly of FIG. 2 including the cassette assembly.

FIG. 4 shows example manifold assemblies that can be used to implement the system of FIG. 1 in a first and/or raised position.

FIG. 5 shows the reagent sipper manifold assembly of FIG. 4 and the carriage of FIG. 4 in a second and/or foil-piercing position.

FIG. 6 shows the reagent sipper manifold assembly of FIG. 4 and the carriage of FIG. 4 in a third and/or lowered position.

FIG. 7 is a detailed cross-sectional view of the distal ends of the sipper tubes of the sample sipper manifold assembly of FIG. 2 and the sample wells of the sample cartridge of FIGS. 4-6.

FIG. 8 is an isometric view of another cassette assembly that can be used with the sample sipper manifold assembly of FIGS. 1 and/or 2.

FIG. 9 is an isometric view of an example sample cartridge that can be used to implement the sample cartridge of FIG. 1.

FIG. 10 is an isometric view of example sample tubes that can be use with the sample cartridge of FIG. 9.

FIG. 11 illustrates a flow chart for a method of using the system of FIG. 1, the sample sipper manifold assembly of FIGS. 1 and 2, and the reagent sipper manifold assembly of FIGS. 1 and 4 or any of the other implementations disclosed herein.

FIG. 12 is an side view of an example sipper manifold assembly that can be used to implement the reagent sipper manifold assembly of FIG. 1.

FIG. 13 is an side view of the sipper manifold assembly of FIG. 12 in the second position.

FIG. 14 is a side view of an alternative flag assembly that can be used to implement the flag assembly of FIG. 12.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

The implementations disclosed herein relate to sipper manifold assemblies that reduce dead volume of samples within sample tubes (e.g., library tubes) and reduce the likelihood that tips/distal ends of the sipper tubes are damaged. The dead volume may be reduced to about 10 microliters (μL) for example. The tips of the sipper tubes are used to puncture a liquid impermeable barrier such as foil that covers sample wells of a sample cartridge and, as such, reduces damage to the tips of the sipper tubes and increases the useful life of the sipper tubes.

Reduction of dead volume in a sample tube can be useful as the volume of a sample provided by a source may be limited and/or several samples may be pooled into a sample volume with unique identifiers. In some situations where a larger dead volume is permitted, some portions of a limited samples may not be extracted or a limited amount may be extracted from the sample tube and/or some samples of a pooled sample volume may not be extracted or a limited amount may be extracted from the sample tube. Reduction of the dead volume may be accomplished through the implementations described herein to achieve better extraction of limited sample amounts. Moreover, if dead volume is reduced, a greater number of samples may be pooled together as the likelihood of extraction of limited amounts can be reduced. Further still, reduction of dead volume can reduce the volume of reagents used for on-board sample preparation, thereby also reducing the size, volume, and/or cost for an instrument and/or for sequencing samples.

The sipper manifold assemblies in some implementations disclosed herein have a cassette assembly including a cassette housing, sipper tubes, and sipper couplings moveably coupled within the cassette housing and to which the sipper tubes are coupled. The cassette assembly also includes one or more biasing elements such as springs or foam positioned between the sipper couplings and the cassette housing that allow the sipper couplings and the associated sipper tubes to move relative to the cassette housing. The sipper couplings and sipper tubes may be independently moveable or movable together (e.g., ganged). The movable coupling between the sipper couplings/sipper tubes and the cassette housing advantageously allows a distal end of the sipper tubes to have a low-force interaction with the sample well that deters the sipper tubes from being damaged.

The distal end of each of the sipper tubes has a first surface positioned at a first angle relative to the longitudinal axis of the corresponding sipper and a second surface defining an opening of the sipper tube positioned at a second angle relative to a longitudinal axis of the corresponding sipper. The second angle is greater than the first angle. The first surface can thus engage a corresponding surface of the sample well while the second surface remains at least partially spaced from the surface of the sample well, thereby allowing the opening to remain unobstructed. The sample tubes may also include a conical portion and a recessed portion (e.g., a dimple) that further deters the distal ends of the sipper tubes from being damaged and/or reduces dead volume.

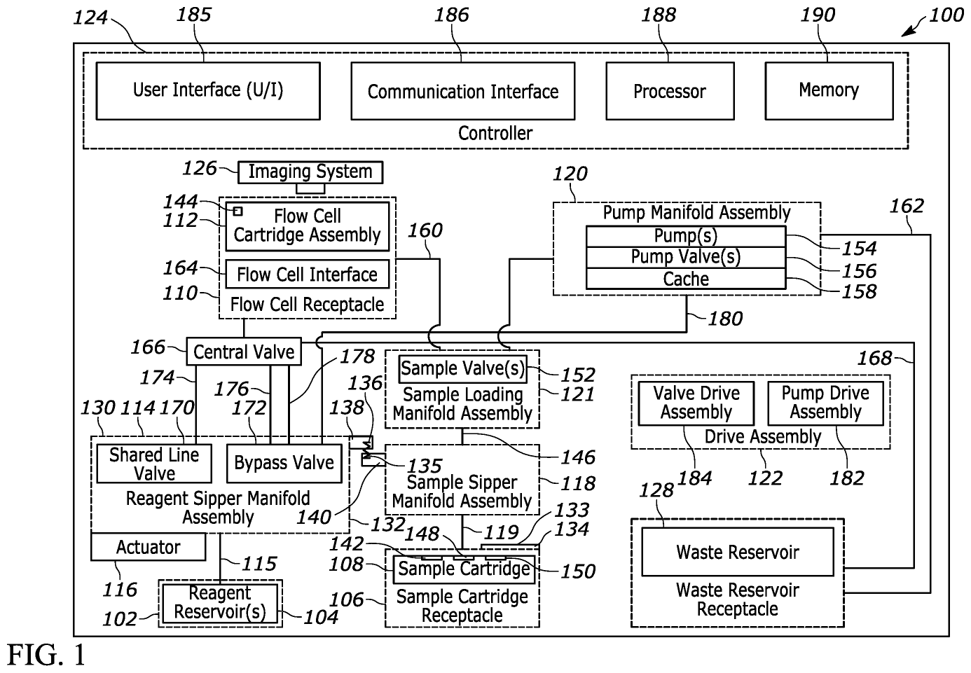

FIG. 1 illustrates a schematic diagram of an implementation of a system 100 in accordance with the teachings of this disclosure. The system 100 can be used to perform an analysis on one or more samples of interest. The sample may include one or more DNA clusters that have been linearized to form a single stranded DNA (sstDNA). The system 100 has a reagent reservoir receptacle 102 that receives a reagent reservoir 104, a sample cartridge receptacle 106 that receives a sample cartridge 108, and a flow cell receptacle 110 that receives a flow cell cartridge assembly 112 in the implementation shown. The system 100 also includes a reagent sipper manifold assembly 114 having one or more reagent sippers 115, an actuator 116, a sample sipper manifold assembly 118 having one or more sample sippers 119, and a pump manifold assembly 120. The system 100 also includes a sample loading manifold assembly 121, a drive assembly 122, a controller 124, an imaging system 126, and a waste reservoir 128. The controller 124 is electrically and/or communicatively coupled to the reagent sipper manifold assembly 114, the actuator 116, the sample sipper manifold assembly 118, the pump manifold assembly 120, the sample loading manifold assembly 121, the drive assembly 122, the controller 124, and the imaging system 126 and is adapted to cause the reagent sipper manifold assembly 114, the actuator 116, the sample sipper manifold assembly 118, the pump manifold assembly 120, the sample loading manifold assembly 121, the drive assembly 122, the controller 124, and the imaging system 126 to perform various functions as disclosed herein.

The reagent sipper manifold assembly 114 has a first end 130 to which the actuator 116 is coupled to move the reagent sipper manifold assembly 114 relative to the reagent reservoirs 104 and a second end 132. The actuator 116 moves the reagent sipper manifold assembly 114 in operation toward the reagent reservoir receptacle 102 causing the second end 132 of the reagent sipper manifold assembly 114 to engage the sample sipper manifold assembly 118 and move the sample sippers 119 toward the sample cartridge receptacle 106. The actuator 116 may be a linear actuator. The reagent reservoir receptacle 102 also has a surface 133 formed as a platform 134 that is engageable by the sample sipper manifold assembly 118 when the sample sippers 119 draw fluid from the sample cartridge 108.

A biasing element 135 shown as a spring 136 in the implementation shown couples the reagent sipper manifold assembly 114 and the sample sipper manifold assembly 118 and is used to urge the sample sippers 115 away from the sample cartridge receptacle 106 when the reagent sipper manifold assembly 114 moves away from the reagent reservoir receptacle 102. The biasing element 135 may be referred to a return spring. The manifold assemblies 114, 118 may, however, be coupled in different ways.

The second end 132 of the reagent sipper manifold assembly 114 has a lip 138 and the sample sipper manifold assembly 118 has a lip 140. The lips 138, 140 engage when the reagent sipper manifold assembly 114 engages the sample sipper manifold assembly 118 and moves the sample sippers 119 toward the sample cartridge receptacle 106. The biasing element 135 is shown being coupled to and between the lips 138, 140. The biasing element 135 may, however, be coupled to the manifold assemblies 114, 118 in different locations. In some implementations, only one of the second end 132 of the reagent sipper manifold assembly 114 has a lip 138 or the sample sipper manifold assembly 118 has a lip 140. For instance, the lip 138 may engage with a surface of the sample sipper manifold assembly 118 to move the sample sippers 119 toward the sample cartridge receptacle 106 when the reagent sipper manifold assembly 114 is moved. In another implementation, the lip 140 may engage with a surface of the reagent sipper manifold assembly 114 to move the sample sippers 119 toward the sample cartridge receptacle 106 when the reagent sipper manifold assembly 114 is moved.

The sample cartridge 108 carries one or more samples of interest (e.g., an analyte) in samples wells 142 and is receivable in the sample cartridge receptacle 106. The sample sippers 119 are used to draw the samples from the sample wells 142 and the sample is delivered to a flow cell 144 of the flow cell cartridge assembly 112 by sample fluidic lines 146. The sample wells 142 may be referred to as sample reservoirs. One of the sample fluidic lines 146 is coupled to each sample sipper 119 and the sample fluidic lines 146 are fluidically coupled to the flow cell 144 by, for example, the sample loading manifold assembly 121. The sample cartridge 108 also includes prime wells 148 and one or more wash wells 150 that may contain a wash buffer and/or a cleaning solution such as bleach.

The sample loading manifold assembly 121 includes one or more sample valves 152 and the pump manifold assembly 120 includes one or more pumps 154, one or more pump valves 156, and a cache 158. One or more of the valves 152, 156 may be implemented by a rotary valve, a pinch valve, a flat valve, a solenoid valve, a check valve, a piezo valve, and/or a three-way valve. Other types of fluid control devices may prove suitable. One or more of the pumps 154 may be implemented by a syringe pump, a peristaltic pump, and/or a diaphragm pump. Other types of fluid transfer devices may prove suitable. The cache 158 may be a serpentine cache and may be adapted to receive a volume of about 4 milliliters (mL). The cache 158 may temporarily store one or more reaction components during, for example, bypass manipulations of the system 100 of FIG. 1. While the cache 158 is shown being included in the pump manifold assembly 120, the cache 158 may be located in a different location. The cache 158 may be included in the reagent sipper manifold assembly 114 or in another location.

The sample sipper manifold assembly 118 in operation draws one or more samples from the sample wells 142 and the sample loading manifold assembly 121 and the pump manifold assembly 120 flow the one or more samples of interest from the sample cartridge 108 through a fluidic line 160 toward the flow cell cartridge assembly 112. The flow cell cartridge assembly 112 includes the flow cell 144 having a plurality of channels (e.g., two channels, four channels, eight channels). The flow cell 144, however, may have a single channel or the flow cell 144 may be omitted and/or replaced with another detection device. The sample loading manifold assembly 121 may be adapted to individually load/address each channel of the flow cell 144 with a sample of interest automatically using the system 100 of FIG. 1.

The sample cartridge 108 and the sample loading manifold assembly 118 are positioned downstream of the flow cell cartridge assembly 112. The sample loading manifold assembly 121 may thus load a sample of interest into the flow cell 144 from the rear of the flow cell 144. Loading a sample of interest from the rear of the flow cell 144 may be referred to as “back loading” and may reduce contamination. The sample loading manifold assembly 121 is coupled between the flow cell cartridge assembly 112 and the pump manifold assembly 120.

The pumps 154 draw the hybridization buffer through the flow cell 144 to prime the system 100 with, for example, the hybridization buffer and/or to remove air from the system 100 and the sample sipper manifold assembly 118 dispenses the hybridization buffer into the prime wells 148 once the system 100 is primed. The sample of interest is thereafter drawn from the sample cartridge 108 using the sample sippers 119 and the sample valves 152, the pump valves 156, and/or the pumps 154 selectively actuate to urge the sample of interest toward the pump manifold assembly 120. The sample cartridge 108 is shown including the sample wells 142 that are selectively fluidically accessible via the corresponding sample sippers 119. Each sample can thus be selectively isolated from other samples using the corresponding sample sippers 119 and the corresponding sample valves 152.

A sample valve 152 for the corresponding sample of interest can be opened or released to fluidically connect the sample well 142 to an instrument fluidics system to draw the sample of interest from one of the sample wells 142. A corresponding pump 154 of the pump manifold assembly 120 can be actuated to draw the sample of interest from the sample well 142 and into a fluidic line, such as a fluidic line of the pump manifold assembly 120 and/or another fluidic line. A corresponding pump valve 156 can be opened, closed, and/or moved from a first position to a second position to fluidically couple the corresponding pump 154 to the fluidic line for the corresponding sample well 142. The pump valve 156 can be selectively isolated from other pumps 154 and/or pump valves 156 and a sample of interest can be temporarily stored in a line volume between a pump valve 156 and/or a sample valve 152 and a corresponding pump 154 in some implementations.

The sample valves 152, the pump valves 156, and/or the pumps 154 may be selectively actuated to urge the sample of interest toward the flow cell cartridge assembly 112 and into the respective channels of the flow cell 144 to individually flow the sample of interest toward a corresponding channel or channels of the flow cell 144 and away from the pump manifold assembly 120. After the sample of interest is aspirated into a line volume for instance, the sample valve 152 can be closed, thereby fluidically disconnecting the sample wells 142 from the line volume. The sample valve 152 may be moved from a first position to a second position in some instances to fluidically couple the corresponding pump 154 to the corresponding channel or channels via the sample loading manifold assembly 121. The pump 154 can then push the sample of interest into the corresponding channel or channel of the flow cell 144. A corresponding pump valve 156 may be opened, closed, and/or moved from a second position to a first position in some implementations to fluidically couple the corresponding pump 154 to the corresponding channel or channels. Each channel of the plurality of channels of the flow cell 144 receives the sample of interest in some implementations and one or more of the channels may selectively receive the sample of interest and others of the channels may not receive the sample of interest. The channels of the flow cell 144 that may not be receive the sample of interest may receive a wash buffer instead, for example.

The drive assembly 122 interfaces with the reagent sipper manifold assembly 114 and the pump manifold assembly 120 to flow one or more reagents that interact with the sample at the flow cell 144 through the flow cell cartridge assembly 112. In an implementation, a reversible terminator with an identifiable label is attached to the reagent to allow a single nucleotide to be incorporated by the sstDNA per cycle. In some such implementations, one or more of the nucleotides has a unique fluorescent label that emits a color when excited. The color (or absence thereof) is used to detect the corresponding nucleotide. The imaging system 126 is adapted to excite one or more of the identifiable labels (e.g., a fluorescent label) and thereafter obtain image data for the identifiable labels in the implementation shown. The labels may be excited by incident light and/or a laser and the image data may include one or more colors emitted by the respective labels in response to the excitation. The image data (e.g., detection data) may be analyzed by the system 100. The imaging system 126 may be a fluorescence spectrophotometer including an objective lens and/or a solid-state imaging device. The solid-state imaging device may include a charge coupled device (CCD) and/or a complementary metal oxide semiconductor (CMOS).

The drive assembly 122 interfaces with the reagent sipper manifold assembly 114 and the pump manifold assembly 120 in some implementations after the image data is obtained to flow another reaction component (e.g., a reagent) through the flow cell 144 that is thereafter received by the waste reservoir 128 via a primary waste fluidic line 162 and/or otherwise exhausted by the system 100. Some reaction components perform a flushing operation that chemically cleaves the fluorescent label and the reversible terminator from the sstDNA. The sstDNA is then ready for another cycle. The sample sippers 119 are cleaned between runs of the system 100 in some implementations by dipping the sample sippers 119 in the wash wells 150 containing a cleaning solution such as bleach or a wash buffer. The cleaning solution is removable by dipping the sample sippers 119 in the prime wells 148 containing the hybridization buffer. Other approaches of cleaning the sample sippers 119 may be suitable however.

The primary waste fluidic line 162 is coupled between the pump manifold assembly 120 and the waste reservoir 128. The pumps 154 and/or the pump valves 156 of the pump manifold assembly 120 selectively flow the reaction components from the flow cell cartridge assembly 112, through the fluidic line 160 and the sample loading manifold assembly 118 to the primary waste fluidic line 162.

The flow cell cartridge assembly 112 is receivable in the flow cell receptacle 110 and is couplable with a flow cell interface 164. The flow cell receptacle 110 may, however, be excluded and the flow cell cartridge assembly 112 may be directly coupled to the flow cell interface 164.

The flow cell cartridge assembly 112 is coupled to a central valve 166 via the flow cell interface 164. An auxiliary waste fluidic line 168 is coupled to the central valve 166 and to the waste reservoir 128. The auxiliary waste fluidic line 168 in some implementations is adapted to receive any excess fluid of a sample of interest from the flow cell cartridge assembly 112, via the central valve 166, and to flow the excess fluid of the sample of interest to the waste reservoir 128 when back loading the sample of interest into the flow cell 144, as described herein. That is, the sample of interest may be loaded from the rear of the flow cell 144 and any excess fluid for the sample of interest may exit from the front of the flow cell 144. Different samples can be separately loaded to corresponding channels of the flow cell 144 by back loading samples of interest into the flow cell 144 and a single manifold can couple the front of the flow cell 144 to the central valve 166 to direct excess fluid of each sample of interest to the auxiliary waste fluidic line 168 and reduce the likelihood of contamination of samples between channels of the flow cell 144. The single manifold can be used for delivering common reagents from the front of the flow cell 144 (e.g., upstream) to each channel of the flow cell 144 and common reagents may exit the flow cell 144 from the rear of the flow cell 144 (e.g., downstream). Put another way, the sample of interest and the reagents may flow in opposite directions through the channels of the flow cell 144.

The reagent sipper manifold assembly 114 in the implementation shown includes a shared line valve 170 and a bypass valve 172. The shared line valve 170 may be referred to as a reagent selector valve. The central valve 166 and the valves 170, 172 of the reagent sipper manifold assembly 114 may be selectively actuated to control the flow of fluid through fluidic lines 174, 176, 178. One or more of the valves 166, 170, 172 may be implemented by a rotary valve, a pinch valve, a flat valve, a solenoid valve, a check valve, a piezo valve, etc. Other fluid control devices may prove suitable.

The reagent sipper manifold assembly 114 may be coupled to a corresponding number of the reagents reservoirs 104 via the reagent sippers 115. The reagent reservoirs 104 may contain fluid (e.g., reagent and/or another reaction component). The reagent sipper manifold assembly 114 includes a plurality of ports, where each port of the reagent sipper manifold assembly 114 may receive one of the reagent sippers 115. The reagent sippers 115 may be referred to as fluidic lines.

The shared line valve 170 of the reagent sipper manifold assembly 114 is coupled to the central valve 166 via the shared reagent fluidic line 174 in the implementation shown. Different reagents may flow through the shared reagent fluidic line 174 at different times. The pump manifold assembly 120 may draw wash buffer through the shared reagent fluidic line 174, the central valve 166, and the flow cell cartridge assembly 112 when performing a flushing operation before changing between one reagent and another. The shared reagent fluidic line 174 may thus be involved in the flushing operation. While one shared reagent fluidic line 174 is shown, any number of shared fluidic lines may be included in the system 100.

The bypass valve 172 of the reagent sipper manifold assembly 114 is coupled to the central valve 166 via the dedicated reagent fluidic lines 176, 178. The central valve 166 may have one or more dedicated ports that correspond to the dedicated reagent fluidic lines 176, 178 and each of the dedicated reagent fluidic lines 176, 178 may be associated with a single reagent. The fluids that may flow through the dedicated reagent fluidic lines 176, 178 may be used during sequencing operations and may include a cleave reagent, an incorporation reagent, a scan reagent, a cleave wash, and/or a wash buffer. The reagent sipper manifold assembly 114 may thus draw wash buffer through the central valve 166 and/or the flow cell cartridge assembly 112 when performing a flushing operation before changing between one reagent and another in association with the bypass valve 172. The dedicated reagent fluidic lines 176, 178 themselves, however, may not be flushed because only a single reagent may flow through each of the dedicated reagent fluidic lines 176, 178. The approach of including dedicated reagent fluidic lines 176, 178 may be advantageous when the system 100 uses reagents that may have adverse reactions with other reagents. Moreover, reducing a number of fluidic lines or length of the fluidic lines that are flushed when changing between different reagents reduces reagent consumption and flush volume and may decrease cycle times of the system 100. While two dedicated reagent fluidic lines 176, 178 are shown, any number of dedicated fluidic lines may be included in the system 100.

The bypass valve 172 is also coupled to the cache 158 of the pump manifold assembly 120 via a bypass fluidic line 180. One or more reagent priming operations, hydration operations, mixing operations, and/or transfer operations may be performed using the bypass fluidic line 180. The priming operations, the hydration operations, the mixing operations, and/or the transfer operations may be performed independent of the flow cell cartridge assembly 112. The operations using the bypass fluidic line 145 may thus occur during, for example, incubation of one or more samples of interest within the flow cell cartridge assembly 112. That is, the shared line valve 170 can be utilized independently of the bypass valve 172 such that the bypass valve 172 can utilize the bypass fluidic line 180 and/or the cache 158 to perform one or more operations while the shared line valve 170 and/or the central valve 166 simultaneously, substantially simultaneously, or offset synchronously perform other operations. Performing multiple operations using the system 100 at once may reduce run time. The bypass valve 172 and the bypass fluidic line 180 can be used to flow hybridization buffer through the pump manifold assembly 120 to the sample loading manifold assembly 121 and allow the hybridization buffer to follow the sample of interest through the flow cell 144. The order of fluid flowing through the flow cell 144 may thus be: 1) hybridization buffer from the priming operation; 2) the sample drawn from the sample wells 142 via the sample sippers 121; and 3) the hybridization buffer accessed via the bypass valve 172 and the bypass fluidic valve 180.

Referring now to the drive assembly 122, in the implementation shown, the drive assembly 122 includes a pump drive assembly 182 and a valve drive assembly 184. The pump drive assembly 182 may be adapted to interface with the one or more pumps 154 to pump fluid through the flow cell 144 and/or to load one or more samples of interest into the flow cell cartridge assembly 112. The valve drive assembly 184 may be adapted to interface with one or more of the valves 152, 156, 166, 170, 172 to control the position of the corresponding valves 152, 156, 166, 170, 172. In an implementation, the shared line valve 170 and/or the bypass valve 172 are implemented by rotary valves having a first position that blocks flow to the flow cell 144 and a second position that allows flow from the reagent reservoir 104 to the flow cell 144. However, either of the valves 170, 172 may be positioned in any number of positions to flow any one or more of a first reagent, a buffer reagent, a second reagent, etc. to the flow cell cartridge assembly 112. The bypass valve 172 may be rotated as an example between a first position allowing fluid flow from one or more of the reagent reservoirs 104, through the bypass valve 172, and to the central valve 166 and a second position allowing fluid flow from one or more of the reagent reservoirs 104, through the bypass valve 172, and into the bypass fluidic line 180. Other arrangements may prove suitable. The bypass valve 172 may be positionable to allow fluid flow from the bypass fluidic line 180, through the bypass valve 172, and to a mixing reservoir of the reagent reservoirs 104 for example.

Referring to the controller 124, in the implementation shown, the controller 124 includes a user interface 185, a communication interface 186, one or more processors 188, and a memory 190 storing instructions executable by the one or more processors 188 to perform various functions including the disclosed implementations. The user interface 185, the communication interface 186, and the memory 190 are electrically and/or communicatively coupled to the one or more processors 188.

In an implementation, the user interface 185 is adapted to receive input from a user and to provide information to the user associated with the operation of the system 100 and/or an analysis taking place. The user interface 185 may include a touch screen, a display, a keyboard, a speaker(s), a mouse, a track ball, and/or a voice recognition system. The touch screen and/or the display may display a graphical user interface (GUI).

In an implementation, the communication interface 186 is adapted to enable communication between the system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with a fluidics analysis operation, patient records and/or a protocol(s) to be executed by the system 100.

The one or more processors 188 and/or the system 100 may include one or more of a processor-based system(s) or a microprocessor-based system(s). In some implementations, the one or more processors 188 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit and/or another logic-based device executing various functions including the ones described herein.

The memory 190 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache, and/or any other storage device or storage disk in which information is stored for any duration (e.g., permanently, temporarily, for extended periods of time, for buffering, for caching).

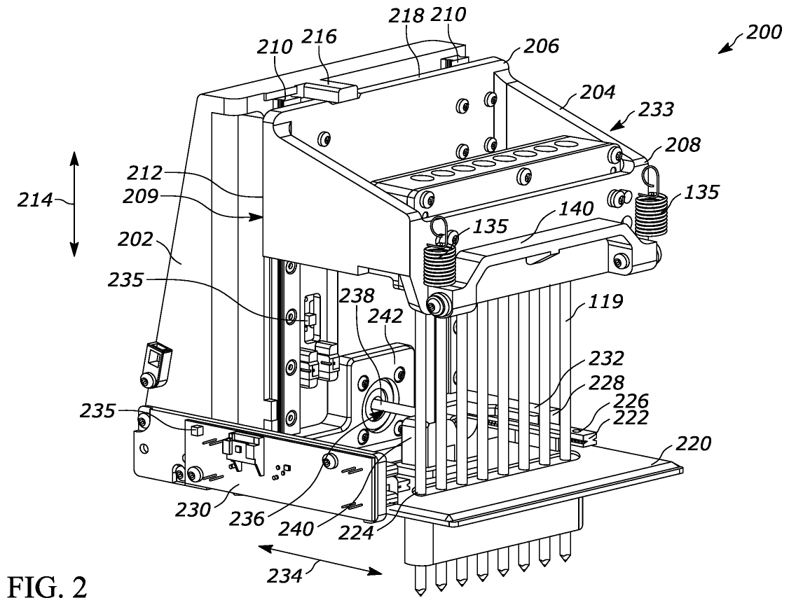

FIG. 2 is an isometric view of an example sample sipper manifold assembly 200 that can be used to implement the sample sipper manifold assembly 118 of FIG. 1. The sipper manifold assembly 200 in the implementation shown has a base 202, a carriage 204 having a first side 206 and a second side 208, and a vertical guide 209 that couples the base 202 and the first side 206 of the carriage 204. The vertical guide 209 is shown being a pair of guide rails 210 coupled to the base 202 and a pair of guide blocks 212 coupled to the carriage 204. The guide rails 210 and the guide blocks 212 are coupled and guide movement of the carriage 204 in directions generally indicate by arrow 214. In some implementations, a single guide rail 210 can be provided. The base 202 includes a stop 216 that is engaged by a top surface 218 of the carriage 204 to limit movement of the carriage 204 and retain the coupling between the guide rails 210 and the guide blocks 212.

The sample sipper manifold assembly 200 also includes a guide 220, a horizontal guide 222 coupling the base 202 and the guide 220, and a cassette assembly 233 carrying the sample sippers 119 and coupled to the carriage 204. The guide 220 can be referred to as a guide plate and defines apertures 224 through which the sample sippers 119 pass. An interaction between the sample sippers 119 and the guide 220 reduces an effective length of the sample sippers 119 and a likelihood that the sample sippers 119 buckle and/or bend.

The horizontal guide 222 includes linear rails 226 carried by the guide 220 and grooves 228 defined by sides 230, 232 of the base 202 that receive the linear rails 226. A coupling between the linear rails 226 and the grooves 228 guides movement of the guide 220 in directions generally indicated by arrow 234. The sample sipper manifold assembly 200 may include one or more sensors 235 that are used to determine a y-position and/or a z-position of the carriage 204.

The sample sipper manifold assembly 200 also includes a lead screw assembly 236 that is coupled to the base 202 and the guide 220 and is used to move the guide 220 in the directions generally indicated by the arrow 234. The lead screw assembly 236 includes a lead screw 238 carried by the base 202 and a lead nut 240 carried by the guide 220. The lead screw assembly 223 also includes a motor 242 that is used to drive the lead screw 238 and move the guide 220. While the sample sipper manifold assembly 200 is mentioned having the lead screw assembly 236 to move the guide 220 relative to the base 202, the sample sipper manifold assembly 200 can include a different type of actuator.

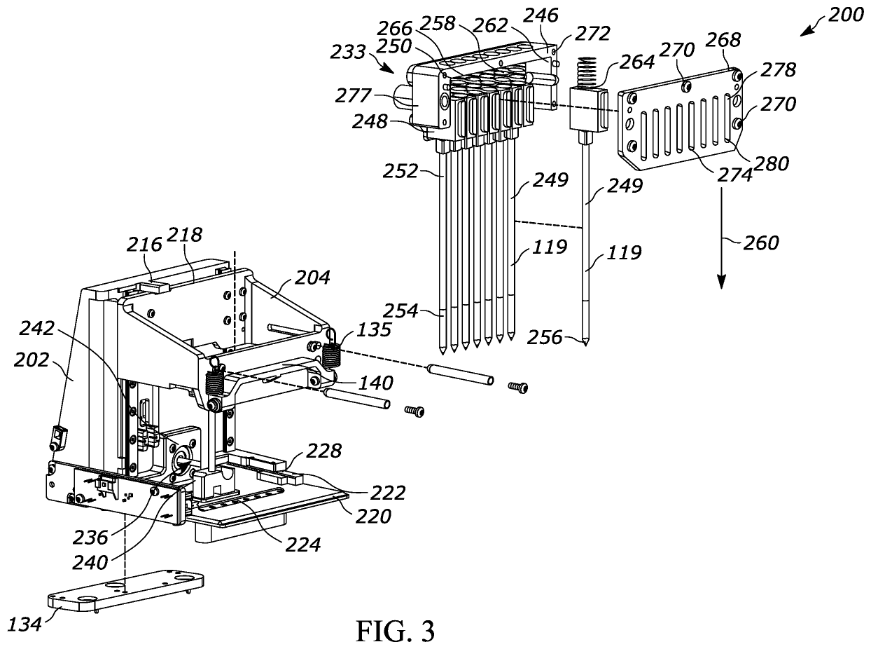

FIG. 3 shows an expanded isometric view of the sipper manifold assembly 200 of FIG. 2 including the cassette assembly 233. The cassette assembly 233 in the implementation shown includes a cassette housing 246, the sample sippers 119 including sipper couplings 248 and sipper tubes 249, and biasing elements 250. The sipper tubes 249 each have a proximal end 252 and a distal end 254, where the proximal end 252 is coupled to a corresponding sipper coupling 248 and each of the distal ends 254 has a tip 256 that is used to puncture a liquid impermeable barrier that covers one or more of the wells 142, 148, 150 of the sample cartridge 108. The biasing elements 250 are shown as coil springs 258 that bias the sipper couplings 248 in a direction generally indicated by arrow 260 and allow relative movement between the sample sippers 119 and the cassette housing 246. The movable coupling between the sample sippers 119 and the cassette housing 244 advantageously allows the distal ends 254 of the sipper tubes 249 to have a low-force interaction with the wells 142, 148, 150 of the sample cartridge 108 that deters the sample sippers 119 from being damaged. The low-force interaction also allows the tips 256 to remain relatively sharp for puncturing the liquid impermeable barriers even after repeated uses by the system 100.

Referring still the cassette assembly 233, the cassette housing 246 defines a cassette cavity 262 and the sipper couplings 248 are disposed within the cassette cavity 262. Each of the sipper couplings 248 is biased by a corresponding spring 258 that is positioned within the cassette cavity 262. The sipper couplings 248 each have a spring seat 264 and the springs 258 are positioned between the spring seats 264 and a surface 266 of the cassette housing 246. The sample sippers 119 are independently movable as a result, thereby accommodating for height differences between the wells 142, 148, 150 of the sample cartridge 108 and/or manufacturing tolerances for example. The sample sippers 119 can accommodate a height variation of about +/−3 millimeters or a different height.

By providing independent moveability of the sample sippers 119, the cassette assembly 233 can permit each sample sipper 119 to independently reduce the dead volume to a minimum for each corresponding sample tube into which the sample sipper 119 is inserted. Such independent reduction can be useful in implementations where sample tubes may have variable depths, either purposefully or through manufacturing tolerance differences. As noted above, reduction of dead volume to minimal volumes can be useful to achieve better extraction of limited sample amounts, increase the number of samples that may be pooled together, and/or reduce the volume of reagents used for on-board sample preparation, thereby also reducing the size, volume, and/or cost for an instrument and/or for sequencing samples.

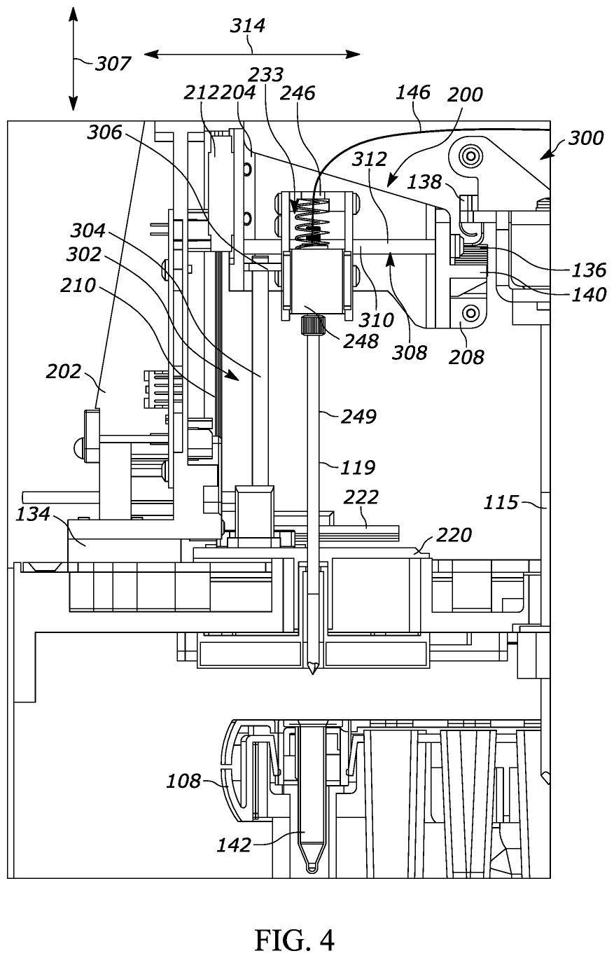

The cassette assembly 233 also has a guide plate 268 that is coupled to the cassette housing 246 by fasteners 270 that pass through the guide plate 268 and are received within corresponding apertures 272 of the cassette housing 246. The guide plate 268 defines slots 274 and each sipper coupling 248 has a protrusion 276 that is movable within the corresponding slot 274. An opposing side 277 of the cassette assembly 233 may include an additional guide plate having slots and the sipper couplings 248 may have additional protrusions 286 receivable within those slots. The sipper couplings 248 each may have two opposing protrusions 275 (see, for example, FIGS. 4-6) and the cassette assembly 233 may have opposing slots.

The protrusion 276 interacts with surfaces of the guide plate 268 defining the slots 274 to linearly guide the sample sippers 119 in the direction generally indicated arrow 260. The slots 274 also have opposing stops 278, 280 that are engageable by the protrusion to limit travel of the sample sippers 119. The protrusions 276 move toward and engage the upper stops 278 when the sipper tubes 249 engage the liquid impermeable barrier covering the wells 142, 148, 150, thereby allowing the sipper tubes 249 to deliver a threshold amount of force to the liquid impermeable barrier to puncture the liquid impermeable barrier. While the slots 274 and the protrusions 276 are stadium shaped, the slots 274 and/or the protrusions 276 may be different shapes.

FIGS. 4, 5, and 6 are cross-sectional views of the sample sipper manifold assembly 200 of FIG. 2 and a portion of an example implementation of a reagent sipper manifold assembly 300 in different positions. The reagent sipper manifold assembly 300 of FIGS. 4-6 can be used to implement the reagent sipper manifold assembly 114 of FIG. 1.

FIG. 4 shows the manifold assemblies 200, 300 in a first and/or raised position and shows the lips 138, 140 spaced from one another. The sample sipper manifold assembly 200 has a vertical guide 302 that couples the guide 220 and the cassette assembly 233. The vertical guide 302 includes a rod 304 and an aperture 306 that receives the rod 304 in the implementation shown. The rod 304 may be referred to as a vertical rod. The rod 304 is coupled to the guide 220 and extends from the guide 220 toward the cassette assembly 233 and the cassette housing 246 defines the aperture 306. The rod 304 and surfaces of the cassette housing 246 defining the aperture 306 interact to guide movement of the carriage 204 in directions generally indicated by arrow 307. The sample sipper manifold assembly 200 also has a horizontal linear guide 308 coupling the cassette assembly 233 and the carriage 204 includes a rod 310 and an aperture 312. The rod 310 extends between the first side 206 and the second side 208 of the carriage 204 and the cassette housing 246 defines the aperture 312. The rod 310 and surfaces of the cassette housing 246 defining the aperture 312 interact to guide movement of the cassette assembly 233 in a directions generally indicated by arrows 314.

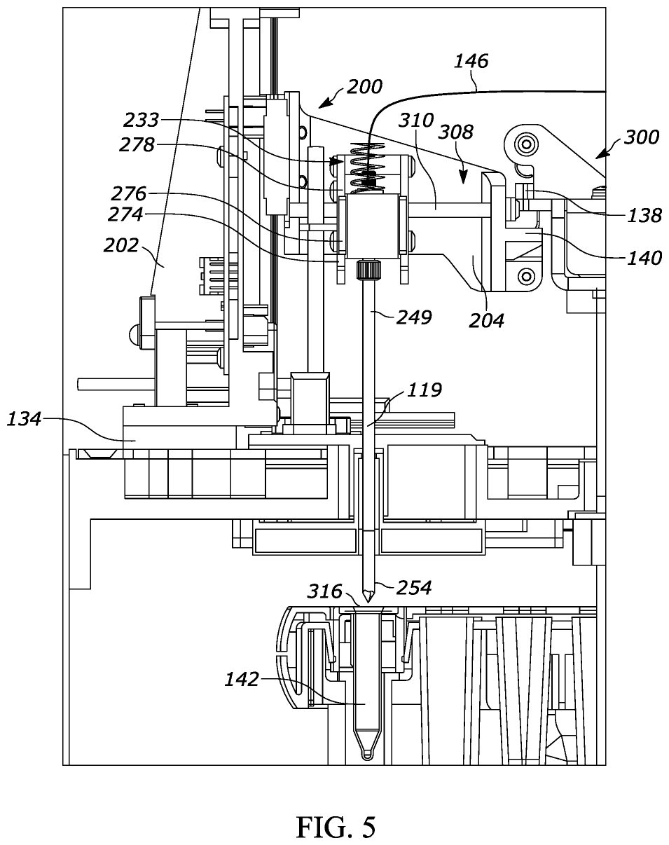

FIG. 5 shows the reagent sipper manifold assembly 300 and the carriage 204 in a second and/or foil-piercing position and the base 202 engaging the platform 134. The lips 138, 140 are shown engaging one another, the protrusion(s) 276 is shown engaging the stop(s) 278 of the slot 274, and the distal end 254 of the sipper tube 249 is shown positioned to pierce a liquid impermeable barrier 316 covering the sample well 142.

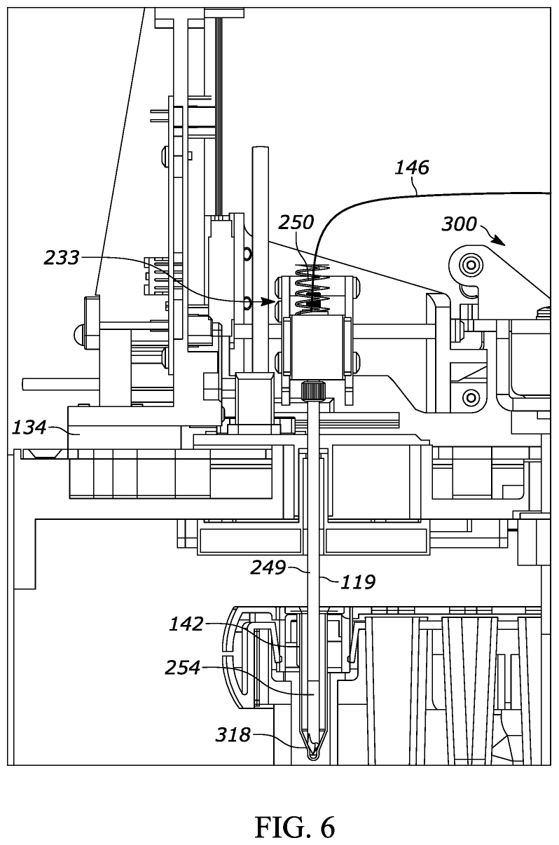

FIG. 6 shows the reagent sipper manifold assembly 300 and the carriage 204 in a third and/or lowered position. The distal end 254 of the sipper tube 249 is shown engaging a bottom surface 318 of the sample well 142 and the biasing elements 250 are shown slightly compressed deterring the sample sipper 119 from being deflected and/or damaged.

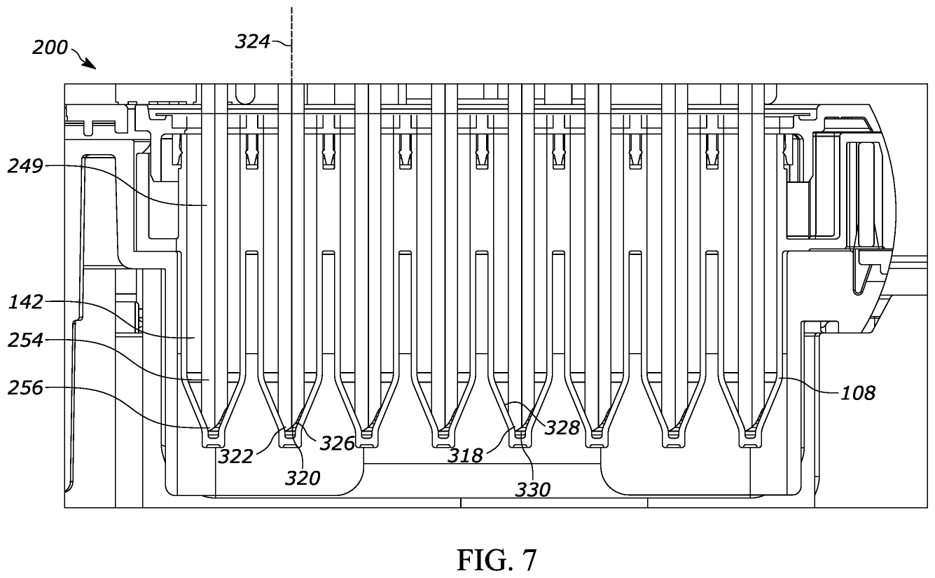

FIG. 7 is a detailed cross-sectional view of the distal ends 254 of the sipper tubes 249 of the sample sipper manifold assembly 200 of FIG. 2 and the sample wells 142 of the sample cartridge 108 of FIGS. 4-6. The sipper tubes 249 each have an opening 320 at the distal end 254 and the tip 256. The tip 256 is formed by a first surface 322 positioned at a first angle relative to a longitudinal axis 324 of the sipper tube 249 and a second surface 326 positioned at a second angle relative to the longitudinal axis 295 in the implementation shown. The surfaces 322, 326 may be referred to as facets. The opening 320 is defined by the second surface 326. The first angle is shown about 30° and the second angle is shown about 50°. The surfaces 322, 326 may be disposed at different angles including the same angle.

The difference between the first and second angles off-sets the tip 256 from the longitudinal axis 295 and allows the opening 320 to be spaced from the tip 256. The first surface 322 engages the bottom surface 318 of the sample well 142 allowing the opening 320 to less likely engage to the bottom surface 318 of the sample well 142 and become occluded and/or obstructed as a result. As a sipper tube 249 may be used to repeatedly puncture seals of sample tubes 249, deformation of the tip 256 via impingement or impacts with a bottom of a sample tube 249 may reduce the effectiveness of the sipper tube 249 to pierce and/or extract samples of future sample tubes 249. Thus, reducing the likelihood of the tip 256 from impinging or impacting with the bottom of a sample well 142 can increase the longevity and usefulness of the sipper tube 249 for future uses. The first surface 322 and the bottom surface 318 of the sample well 142 have corresponding tapers in the implementation shown, the second surface 326 does not flushly engage the bottom surface 318, and the tip 256 extends past the opening 320. The bottom surface 318 of the sample wells 142 has a conical portion 328 and a recessed portion 330 where the conical portion 328 tapers toward the recessed portion 330 to further reduce an amount of dead volume present within the sample wells 142. While the distal ends 254 are mentioned having the two surfaces 322, 326, the distal ends 254 may have three facets or another number of facets.

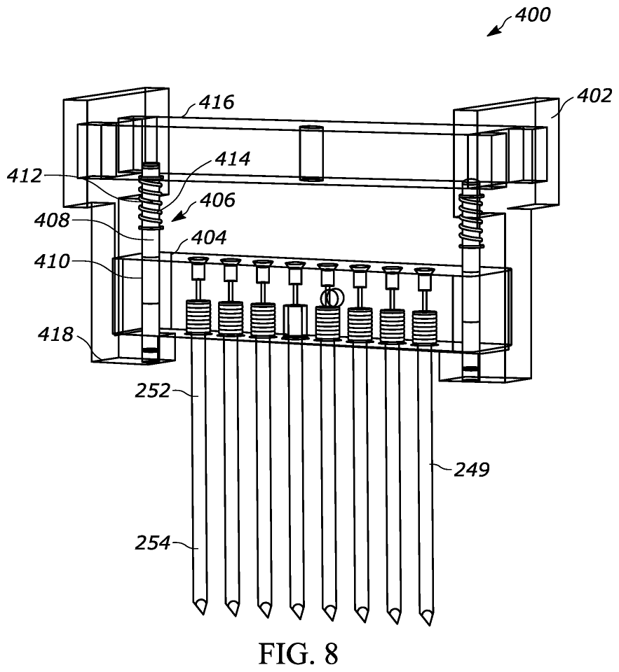

FIG. 8 is an isometric view of another example cassette assembly 400 that can be used with the sample sipper manifold assembly 200 of FIGS. 1 and/or 2. The cassette assembly 400 in the implementation shown includes a cassette housing 402, a sipper coupling 404 movably coupled to the cassette housing 402, and the sipper tubes 249 that are coupled to the sipper coupling 404. Movement of the single sipper coupling 404 thus moves the sipper tubes 249 together.

The proximal ends 252 of the sipper tubes 249 threadably engage the sipper coupling 404 and linear guides 406 guide the movement of the sipper coupling 404 relative to the cassette housing 402. The liner guide 406 includes a pair of rods 408, a pair of apertures 410 that receive the rods 408, and a pair of biasing elements 412 shown as coil springs 414 that bias the sipper coupling 404. The rods 408 are coupled to and between opposing portions 416, 418 of the cassette housing 402 and the sipper coupling 404 defines the apertures 410.

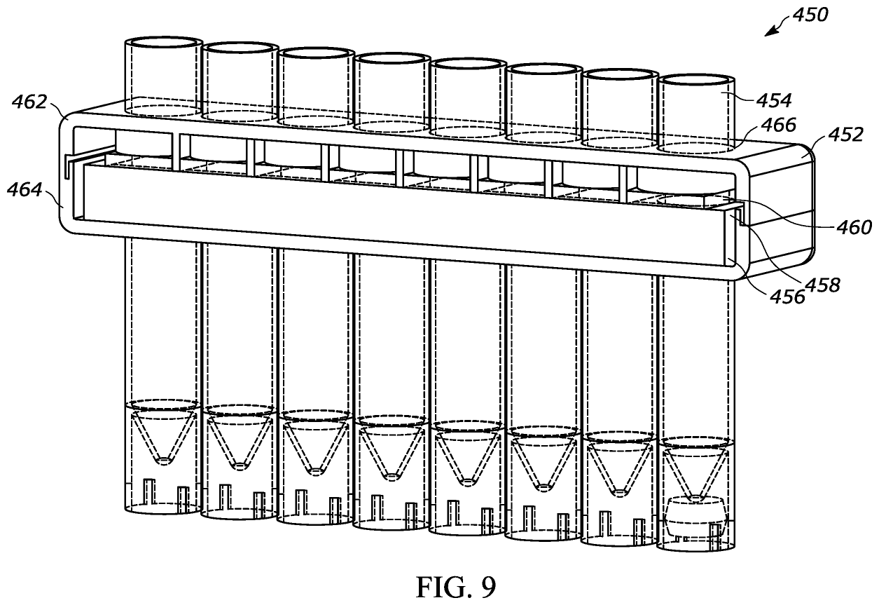

FIG. 9 is an isometric view of an example sample cartridge 450 that can be used to implement the sample cartridge 108 of FIG. 1. The sample cartridge 450 shown includes a housing 452, sample tubes 454 movably coupled to the housing 452, and a biasing element 456 shown as foam 458 that biases the one or more sample tubes 454. The movable coupling between the sample tubes 454 and the housing 452 advantageously allows the sample sippers 119 to have a low-force interaction with the sample tubes 454. The sample tubes 454 are shown having a flange 460 that engages against the foam 458 and being separate from one another allowing the sample tubes 454 to independently move relative to the housing 452. The sample tubes 454, however, may be coupled together such that the samples tubes 454 move together. The samples tubes 454 may be implemented with the independently moveable sample sippers 119 and/or sample tubes 249 of FIGS. 2-7 or with the grouped sipper tubes 249 of FIG. 8 such that the compliance of the biasing element 456 advantageously allows the sample sippers 119 and/or sample tubes 249 to further reduce the low-force interaction with the sample tubes 454.

The housing 452 is a clam shell arrangement having a first portion 462 and a second portion 464 that define aligning apertures 466 that the sample tubes 454 pass through. The foam 458 and the flanges 460 are positioned between the portions 462, 464. While the sample cartridge 450 is shown including foam 458 as the biasing element 456, a different biasing element such as springs may be used.

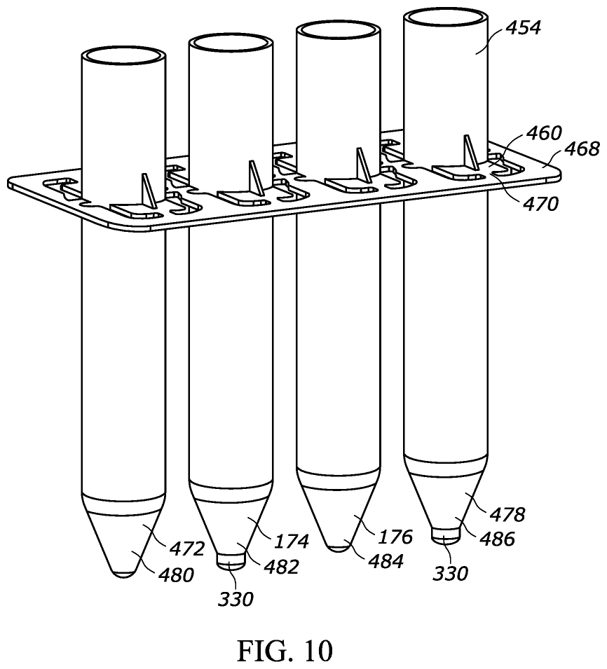

FIG. 10 is an isometric view of example sample tubes 454 that can be use with the sample cartridge 450 of FIG. 9. The sample tubes 454 are coupled to a perimeter flange 468 by frangibles 470 that allow relative movement between the sample tubes 454 and the perimeter flange 468. The frangibles 470 thus act as a biasing element. The frangibles 470 can be broken to allow the sample tubes 454 to be separated from one another. The sample tubes 454 of FIG. 10 have ends 472, 474, 476, 478 having conical portions 480, 482, 484, 486 with different angles and with and without the recessed portion 330. The angles may include, for example, 40°, 46°, 50°, etc. Other angles, however, may prove suitable.

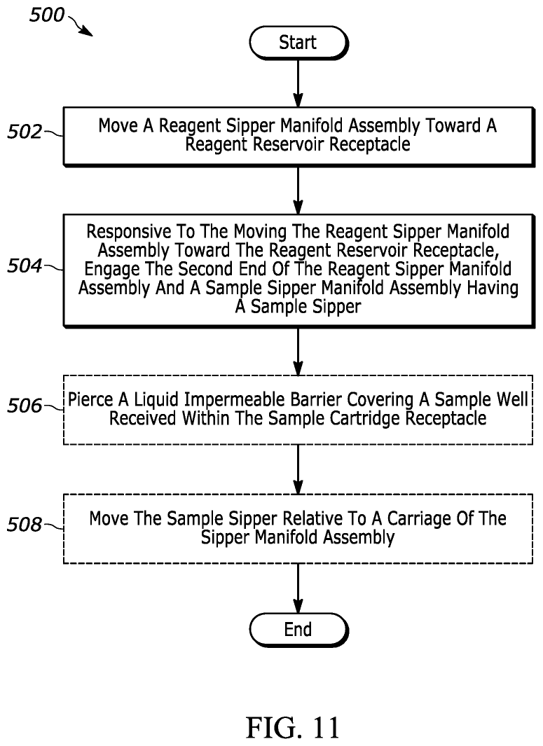

FIG. 11 illustrates a flowchart for methods of using the system 100 of FIG. 1, the sample sipper manifold assembly 118, 200 of FIGS. 1 and 2, and the reagent sipper manifold assembly 114, 300 of FIGS. 1 and 4 or any of the other implementations disclosed herein. In the flow chart of FIG. 11, the blocks surrounded by solid lines may be included in an implementation of a process 500 while the blocks surrounded in dashed lines may be optional in the implementation of the process. Regardless of the way the border of the blocks are presented in FIG. 11, however, the order of execution of the blocks may be changed, and/or some of the blocks described may be changed, eliminated, combined and/or subdivided into multiple blocks.

The process 500 of FIG. 11 begins with the reagent sipper manifold assembly 114, 300 moving toward the reagent reservoir receptacle 102 (Block 502). The reagent sipper manifold assembly 114, 300 has the first end 130 and the second end 132 and includes one or more reagent sippers 115. Responsive to moving the reagent sipper manifold assembly 114, 300 toward the reagent reservoir receptacle 102, the second end 132 of the reagent sipper manifold assembly 114, 300 and the sample sipper manifold assembly having the sample sipper 119 engage (Block 504) and the sample sipper 119 moves toward the sample cartridge receptacle 106 (Block 506). The process 500 also includes piercing the liquid impermeable barrier 316 covering the sample well 142 received within the sample cartridge receptacle 106 (Block 508). The liquid impermeable barrier 316 is pierced in some implementations based on the sipper coupling 248, 404 engaging a stop 278 and the distal end 254 of the sample sipper 119 piercing the liquid impermeable barrier 316. The sample sipper 119 can move relative to the carriage 204 of the sipper manifold assembly 200 (Block 508) by moving the sample sipper 119 against a biasing force provided by one or more springs 136 and/or by foam 458.

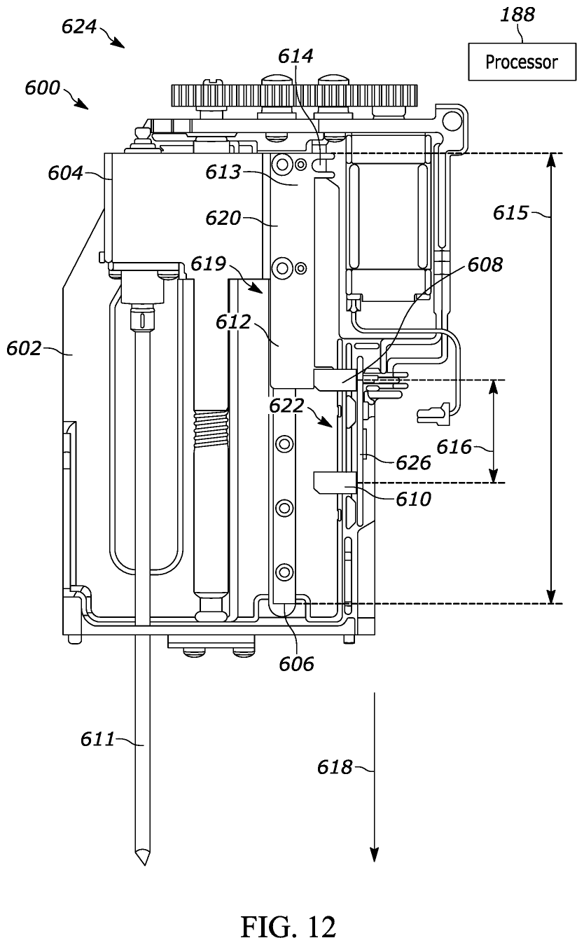

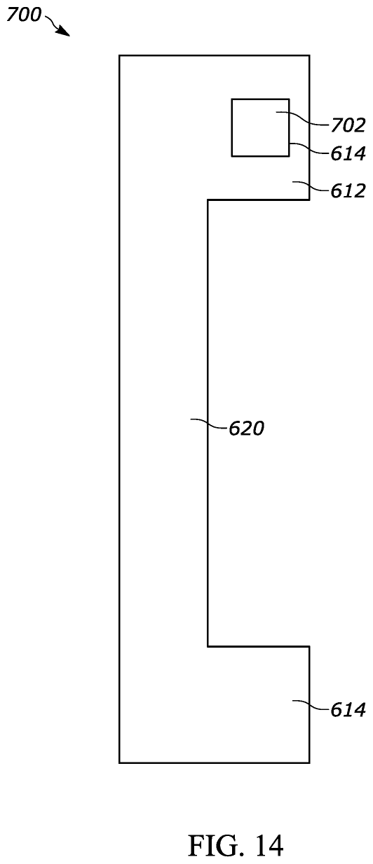

FIG. 12 is an side view of an example sipper manifold assembly 600 that can be used to implement the reagent sipper manifold assembly 114 of FIG. 1. The sipper manifold assembly 600 may be referred to as a reagent sipper manifold assembly. The sipper manifold assembly 600 includes a base 602, a carriage 604, and a vertical guide 606 coupling the base 602 and the carriage 604. The base 602 carries a first sensor 608 and a second sensor 610 that is vertically spaced from the first sensor 608. The carriage 604 carries a sipper 611 and a first flag 612 and a second flag 613 defining an aperture 614. The aperture 614 is shown as a cut-out in the implementation shown. The aperture 614 may alternatively be a through hole 702 (see, FIG. 14) or be another configuration.

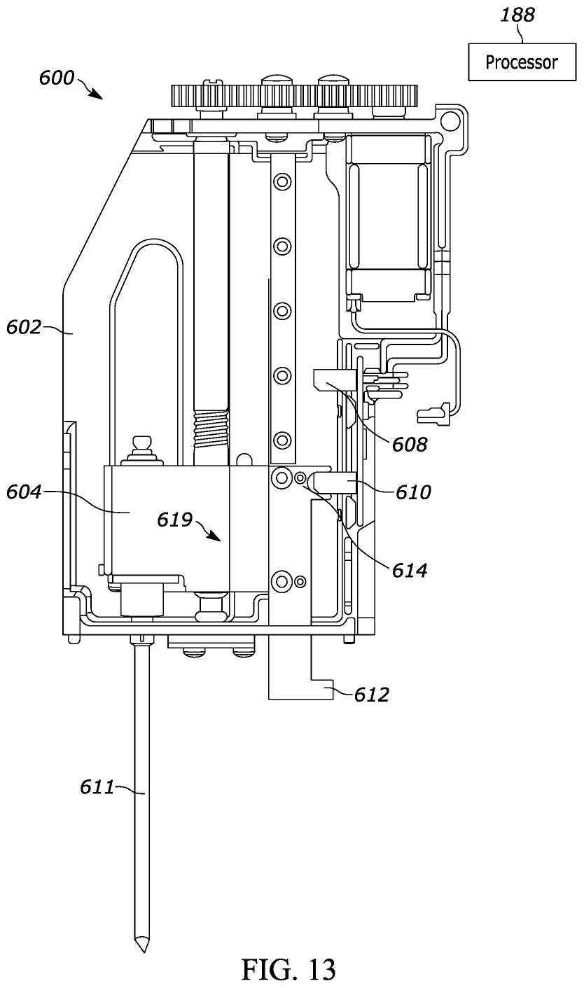

The processor 188 identifies the sipper manifold assembly 600 being in a first position (shown in FIG. 12) in operation based on the first sensor 608 sensing the first flag 612 and not sensing the aperture 614 and identifies the sipper manifold assembly 600 being in a second position (shown in FIG. 13) based on the second sensor 610 sequentially sensing the second flag 613 and then the aperture 614. The first position is a raised position of the sipper manifold assembly 600 and the second position is a lowered position of the sipper manifold assembly 600.

The first position and the second position are shown being a first distance 615 apart and the first sensor 608 and the second sensor 610 are shown being a second distance apart 616. The first distance 615 is greater than the second distance 616 and the first distance 615 may be about 74 millimeters in some implementations.

The processor 188 identifies the sipper manifold assembly 600 being in the second position in some implementations based on the second sensor 610 sequentially sensing the second flag 613 and then sensing the aperture 614. The second sensor 610 sensing the second flag 613 includes the second sensor 610 being in a closed state and the second sensor 610 sensing the aperture 614 includes the second sensor 610 being in an open state. The processor 188 identifying the sipper manifold assembly 600 being in the second position thus includes the second sensor 610 sequentially being in a closed state and then the second sensor 610 being in an open state.

The processor 188 may cause the carriage 604 to move a threshold distance in a direction generally indicated by arrow 618 after the second sensor 610 senses one of the first flag 612 or the second flag 613 or when the second sensor 610 is in a closed state, for example. The processor 188 determines the state of the second sensor 610 after the carriage 604 is moved the threshold distance. The threshold distance may be approximately 2.75 mm or another distance. The aperture 614 of the second flag 613 is aligned with the second sensor 610 when the second sensor 610 is in an open state after the sipper manifold assembly 600 moves the threshold distance and the first flag 612 is aligned with the second sensor 610 when the second sensor 610 is in a closed state after the sipper manifold assembly 600 moves the threshold distance. The processor 188 may not cause further movement of the carriage 604 in the direction generally indicated by arrow 618 when the aperture 614 is aligned with the second senor 610.

The sipper manifold assembly 600 includes a flag assembly 619 including the first flag 612 and the second flag 613. The flag assembly 619 is carried by the carriage 604 and includes a body 620 from which the first flag 612 and the second flag 613 extend. The sipper assembly 600 also includes a sensor assembly 622 and a lead screw assembly 624. The sensor assembly 622 includes a sensor board 626, the first sensor 608, and the second sensor 610. The sensor assembly 622 is carried by the base 602. The lead screw assembly 624 is coupled to the base 602 and to the carriage 604 and is used to move the carriage 604 relative to the base 602. The processor 188 may control movement of the sipper 611 using the flags 612, 612 and the sensors 608, 610 to reduce the likelihood that the sipper 611 contacts a bottom of a well of the reagent reservoir 104 containing reagent, for example. The sipper 611 engaging the bottom of the well may blunt and reduce the useful life of the sipper 611.

FIG. 13 is an side view of the sipper manifold assembly 600 of FIG. 12 in the second position.

FIG. 14 is a side view of an alternative flag assembly 700 that can be used to implement the flag assembly 619 of FIG. 12. The flag assembly 700 is similar to the flag assembly 619 of FIG. 12 but the aperture 614 is shown as a through hole 702 instead of being shown as a cut-out.

An apparatus, comprising: a reagent reservoir receptacle to receive a reagent reservoir; a sample cartridge receptacle to receive a sample cartridge; a reagent sipper manifold assembly having a first end and a second end and including one or more reagent sippers; an actuator coupled to the first end of the reagent manifold assembly to move reagent manifold assembly relative to the reagent reservoir; and a sample sipper manifold assembly having one or more sample sippers. Responsive to the actuator moving the reagent sipper manifold assembly toward the reagent reservoir receptacle, the second end of the reagent sipper manifold assembly engages the sample sipper manifold assembly and moves the one or more sample sippers toward the sample cartridge receptacle.

The apparatus of any one or more of the preceding examples and/or any one or more of the examples disclosed below, further comprising a biasing element coupling the reagent sipper manifold assembly and the sample sipper manifold assembly.

The apparatus of any one or more of the preceding examples and/or any one or more of the examples disclosed below, the biasing element is a spring.

The apparatus of any one or more of the preceding examples and/or any one or more of the examples disclosed below, the second end of the reagent sipper manifold assembly has a lip and the sample sipper manifold assembly has a lip that engage when the second end of the reagent sipper manifold assembly engages the sample sipper manifold assembly and moves the one or more sample sippers toward the sample cartridge receptacle.

The apparatus of any one or more of the preceding examples and/or any one or more of the examples disclosed below, further comprising a flow cell receptacle to receive a flow cell and a sample fluidic line coupled to each sample sipper and fluidically coupled to the flow cell.

The apparatus of any one or more of the preceding examples and/or any one or more of the examples disclosed below, wherein the reagent reservoir receptacle has a surface that is engageable by the sample sipper manifold assembly.

The apparatus of any one or more of the preceding examples and/or any one or more of the examples disclosed below, further comprising a platform having the surface.

The apparatus of any one or more of the preceding examples and/or any one or more of the examples disclosed below, wherein the sample sipper manifold assembly comprises: a base; a carriage having a first side and a second side, the second side including the lip and being operatively coupled to the second end of the reagent sipper manifold assembly; and a vertical guide coupling the base and the first side of the carriage.

The apparatus of any one or more of the preceding examples and/or any one or more of the examples disclosed below, further comprising a guide coupled to the base and defining one or more apertures corresponding to the one or more sample sippers and through which the one or more sippers pass.

The apparatus of any one or more of the preceding examples and/or any one or more of the examples disclosed below, further comprising a horizontal guide coupling the base and the guide.

The apparatus of any one or more of the preceding examples and/or any one or more of the examples disclosed below, further comprising a lead screw assembly coupled to the base and to the guide.

The apparatus of any one or more of the preceding examples and/or any one or more of the examples disclosed below, wherein the lead screw assembly comprises a lead screw carried by the base and a lead nut carried by the guide.

The apparatus of any one or more of the preceding examples and/or any one or more of the examples disclosed below, further comprising a cassette assembly carrying the one or more sample sippers and coupled to the carriage.

An apparatus, comprising: a cassette assembly of a sipper manifold assembly, comprising: a cassette housing; one or more sipper tubes having a proximal end and a distal end; one or more sipper couplings to which the proximal end of the sipper tubes are coupled and that is movably coupled to the cassette housing; one or more biasing elements to bias the one or more sipper couplings. The one or more biasing elements allow relative movement between the sipper tubes and the cassette housing.

The apparatus of any one or more of the preceding examples and/or any one or more of the examples disclosed below, wherein the cassette housing defining a cassette cavity and the one or more sipper couplings are disposed within the cassette cavity.

The apparatus of any one or more of the preceding examples and/or any one or more of the examples disclosed below, wherein the one or more sipper tubes comprises a plurality of sipper tubes and the one or more sipper couplings comprises a plurality of sipper couplings.

The apparatus of any one or more of the preceding examples and/or any one or more of the examples disclosed below, wherein each sipper coupling has a corresponding biasing element.

The apparatus of any one or more of the preceding examples and/or any one or more of the examples disclosed below, wherein each sipper coupling comprises a spring seat and the one or more biasing elements comprise one or more springs positioned between each spring seat and the cassette housing.

The apparatus of any one or more of the preceding examples and/or any one or more of the examples disclosed below, wherein the sipper couplings and corresponding sipper tubes are independently movable.

The apparatus of any one or more of the preceding examples and/or any one or more of the examples disclosed below, further comprising a guide plate coupled to the cassette housing and defining one or more slots, and wherein each sipper coupling has a protrusion movable within the corresponding slot.

The apparatus of any one or more of the preceding examples and/or any one or more of the examples disclosed below, wherein each slot has opposing stops engageable by the corresponding protrusion.

The apparatus of any one or more of the preceding examples and/or any one or more of the examples disclosed below, wherein the sample sipper manifold assembly further comprises: a base; a carriage carrying the cassette assembly; and a vertical guide coupling the base and the first side of the carriage.

The apparatus of any one or more of the preceding examples and/or any one or more of the examples disclosed below, further comprising a guide coupled to the base and defining one or more apertures corresponding to the one or more sample sippers and through which the one or more sippers pass.

The apparatus of any one or more of the preceding examples and/or any one or more of the examples disclosed below, further comprising a horizontal guide coupling the base and the guide.

The apparatus of any one or more of the preceding examples and/or any one or more of the examples disclosed below, further comprising a vertical guide coupling the guide and the cassette assembly.

The apparatus of any one or more of the preceding examples and/or any one or more of the examples disclosed below, wherein the vertical guide comprises a rod coupled to the guide and an aperture of the cassette housing receiving the rod.

The apparatus of any one or more of the preceding examples and/or any one or more of the examples disclosed below, wherein the one or more sipper tubes comprises a plurality of sipper tubes that are coupled to the sipper coupling.

The apparatus of any one or more of the preceding examples and/or any one or more of the examples disclosed below, wherein the sipper tubes move together.

The apparatus of any one or more of the preceding examples and/or any one or more of the examples disclosed below, where the distal end of each of the sipper tubes has a first surface positioned at a first angle relative to a longitudinal axis of the corresponding sipper and a second surface positioned at a second angle relative to the longitudinal axis of the corresponding sipper.

The apparatus of any one or more of the preceding examples and/or any one or more of the examples disclosed below, further comprising a horizontal linear guide coupling the cassette assembly and the carriage.

An apparatus, comprising: a sample cartridge comprises: a housing; one or more sample tubes movably coupled to the housing; and a biasing element that biases the one or more sample tubes.

The apparatus of any one or more of the preceding examples and/or any one or more of the examples disclosed below, wherein the one or more sample tubes comprise a plurality of sample tubes.

The apparatus of any one or more of the preceding examples and/or any one or more of the examples disclosed below, wherein the sample tubes are independently movable relative to the housing.

The apparatus of any one or more of the preceding examples and/or any one or more of the examples disclosed below, wherein the sample tubes are coupled together and have a flange that engages the biasing element.

The apparatus of any one or more of the preceding examples and/or any one or more of the examples disclosed below, wherein the biasing element comprises foam.

The apparatus of any one or more of the preceding examples and/or any one or more of the examples disclosed below, wherein the one or more sample tubes have a conical portion that tapers toward a recessed portion.

A method, comprising: moving a reagent sipper manifold assembly toward a reagent reservoir receptacle, the reagent sipper manifold assembly having a first end and a second end and including one or more reagent sippers; responsive to the moving the reagent sipper manifold assembly toward the reagent reservoir receptacle, engaging the second end of the reagent sipper manifold assembly and a sample sipper manifold assembly having a sample sipper; and moving the sample sipper toward a sample cartridge receptacle.

The method of any one or more of the preceding examples and/or any one or more of the examples disclosed below, further comprising piercing a liquid impermeable barrier covering a sample well received within the sample cartridge receptacle.

The method of any one or more of the preceding examples and/or any one or more of the examples disclosed below, wherein piercing the liquid impermeable barrier comprises a sipper coupling of the sample sipper engaging a stop and a distal end of the sample sipper piercing the liquid impermeable barrier.

The method of any one or more of the preceding examples and/or any one or more of the examples disclosed below, further comprising moving the sample sipper relative to a carriage of the sipper manifold assembly.

The method of any one or more of the preceding examples and/or any one or more of the examples disclosed below, wherein moving the sample sipper comprising moving the sample sipper against a biasing force.

The method of any one or more of the preceding examples and/or any one or more of the examples disclosed below, wherein the biasing force is provided by one or more springs.

The method of any one or more of the preceding examples and/or any one or more of the examples disclosed below, wherein the biasing force is provided by foam.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a reagent reservoir receptacle to receive a reagent reservoir;
a sample cartridge receptacle to receive a sample cartridge;
a reagent sipper manifold assembly having a first end and a second end and including one or more reagent sippers;
an actuator coupled to the first end of the reagent sipper manifold assembly to move the reagent sipper manifold assembly relative to the reagent reservoir receptacle; and
a sample sipper manifold assembly having one or more sample sippers,
wherein, responsive to the actuator moving the reagent sipper manifold assembly toward the reagent reservoir receptacle, the second end of the reagent sipper manifold assembly engages the sample sipper manifold assembly and moves the one or more sample sippers toward the sample cartridge receptacle.

2. The apparatus of claim 1, further comprising a biasing element coupling the reagent sipper manifold assembly and the sample sipper manifold assembly.

3. (canceled)

4. The apparatus of claim 1, wherein at least one of 1) the second end of the reagent sipper manifold assembly has a lip that engages the sample sipper manifold assembly when the second end of the reagent sipper manifold assembly engages the sample sipper manifold assembly and moves the one or more sample sippers toward the sample cartridge receptacle or 2) the sample sipper manifold assembly has a lip that engages with the second end of the reagent sipper manifold assembly when the second end of the reagent sipper manifold assembly engages the sample sipper manifold assembly and moves the one or more sample sippers toward the sample cartridge receptacle.

5. (canceled)

6. (canceled)

7. (canceled)

8. The apparatus of claim 1, wherein the sample sipper manifold assembly comprises:
a base;
a carriage having a first side and a second side, the second side including the lip and being operatively coupled to the second end of the reagent sipper manifold assembly; and
a vertical guide coupling the base and the first side of the carriage.

9. The apparatus of claim 8, further comprising a guide coupled to the base and defining one or more apertures corresponding to the one or more sample sippers and through which the one or more sample sippers pass.

10. The apparatus of claim 9, further comprising a horizontal guide coupling the base and the guide.

11. The apparatus of claim 9, further comprising a lead screw assembly coupled to the base and to the guide.

12. (canceled)

13. (canceled)

14. An apparatus, comprising:
a cassette assembly of a sipper manifold assembly, comprising:
a cassette housing;
one or more sipper tubes having a proximal end and a distal end;
one or more sipper couplings to which the proximal end of the sipper tubes are coupled and that is movably coupled to the cassette housing; and
one or more biasing elements to bias the one or more sipper couplings,
wherein the one or more biasing elements allow relative movement between the sipper tubes and the cassette housing.

15. The apparatus of claim 14, wherein the cassette housing defines a cassette cavity and the one or more sipper couplings are disposed within the cassette cavity.

16. The apparatus of claim 14, wherein the one or more sipper tubes comprises a plurality of sipper tubes and the one or more sipper couplings comprises a plurality of sipper couplings.

17. The apparatus of claim 16, wherein each sipper coupling has a corresponding biasing element.

18. The apparatus of claim 14, wherein each sipper coupling comprises a spring seat and the one or more biasing elements comprise one or more springs positioned between each spring seat and the cassette housing.

19. The apparatus of claim 14, wherein the sipper couplings and corresponding sipper tubes are independently movable.

20. The apparatus of claim 14, further comprising a guide plate coupled to the cassette housing and defining one or more slots, and wherein each sipper coupling has a protrusion movable within the corresponding slot, wherein each slot has opposing stops engageable by the corresponding protrusion.

21. (canceled)

22. The apparatus of claim 14, further comprising the sipper manifold assembly, wherein the sipper manifold assembly further comprises:
a base;
a carriage carrying the cassette assembly; and
a vertical guide coupling the base and the first side of the carriage.

23. The apparatus of claim 22, further comprising a guide coupled to the base and defining one or more apertures corresponding to the one or more sample sippers and through which the one or more sippers pass, further comprising a horizontal guide coupling the base and the guide and a vertical guide coupling the guide and the cassette assembly, wherein the vertical guide comprises a rod coupled to the guide and an aperture of the cassette housing receiving the rod.

24. (canceled)

25. (canceled)

26. (canceled)

27. The apparatus of claim 14, wherein the one or more sipper tubes comprises a plurality of sipper tubes that are coupled to the sipper coupling.

28. The apparatus of claim 27, wherein the sipper tubes move together.

29. The apparatus of claim 14, wherein the distal end of each of the sipper tubes has a first surface positioned at a first angle relative to a longitudinal axis of the corresponding sipper tube and a second surface positioned at a second angle relative to the longitudinal axis of the corresponding sipper tube.

30. (canceled)

31. (canceled)

32. (canceled)

33. (canceled)

34. (canceled)

35. (canceled)

36. (canceled)

37. A method, comprising:
moving a reagent sipper manifold assembly toward a reagent reservoir receptacle, the reagent sipper manifold assembly having a first end and a second end and including one or more reagent sippers;
responsive to moving the reagent sipper manifold assembly toward the reagent reservoir receptacle, engaging the second end of the reagent sipper manifold assembly and a sample sipper manifold assembly having a sample sipper; and
moving the sample sipper toward a sample cartridge receptacle.

38. The method of claim 37, further comprising piercing a liquid impermeable barrier covering a sample well received within the sample cartridge receptacle.

39. The method of claim 38, wherein piercing the liquid impermeable barrier comprises a sipper coupling of the sample sipper engaging a stop and a distal end of the sample sipper piercing the liquid impermeable barrier.

40. The method of claim 37, further comprising moving the sample sipper relative to a carriage of the sample sipper manifold assembly, wherein moving the sample sipper comprises moving the sample sipper against a biasing force and wherein the biasing force is provided by at least one of one or more springs or foam.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)
